(19) United States
(12) Patent Application Publication
(10) Pub. No.: US 2016/0115057 A1
(43) Pub. Date: Apr. 28, 2016

(54) FILTRATION DEVICE AND FILTRATION METHOD USING THE SAME

(71) Applicant: SUMITOMO ELECTRIC INDUSTRIES, LTD., Osaka (JP)

(72) Inventors: Hiromu TANAKA, Osaka (JP); Toru MORITA, Osaka (JP)

(21) Appl. No.: 14/893,617

(22) PCT Filed: Apr. 25, 2014
(86) PCT No.: PCT/JP2014/061646

§ 371 Date: Nov. 24, 2015

(30) Foreign Application Priority Data
May 30, 2013 (JP) 2013-114574

(51) Int. Cl. C02F 3/12; B01D 63/02; B01D 65/08

(52) U.S. Cl. CPC C02F 3/1273; B01D 65/08; B01D 63/02; B01D 2315/06; B01D 2313/08

(57) ABSTRACT

The present invention provides a filtration device comprising a filtration tank that stores a liquid to be treated, the liquid containing a microorganism; an immersion-type filtration module that is disposed in the filtration tank and that includes a plurality of separation membranes; and a first gas supply unit that generates bubbles for cleaning the separation membranes from below the immersion-type filtration module. The filtration device further includes a second gas supply unit that is arranged in a lower portion of the filtration tank so as to be spaced apart from the first gas supply unit and that generates bubbles for supplying oxygen. A bubble-rising prevention zone is formed above the second gas supply unit by the generation of the bubbles from the first gas supply unit. A downflow of the liquid to be treated is preferably present in the bubble-rising prevention zone. A turbulence flow of the liquid to be treated may be present in the bubble-rising prevention zone.

### TECHNICAL FIELD

The present invention relates to a filtration device and a filtration method using the same.

### BACKGROUND ART

In a treatment of waste water such as sewage water containing organic substances or industrial waste water, a filtration treatment (activated sludge treatment) is used in which removal of organic components by microorganisms and separation of suspended solids with a filtration membrane are combined. In general, a device for such a filtration treatment includes a filtration tank to which a liquid to be treated is supplied, in which aerobic microorganisms are added to the filtration tank at a constant concentration, and an immersion-type filtration module that collects a filtered liquid through a filtration membrane is arranged in the filtration tank in an immersed manner.

As such a filtration device, a filtration device that includes an immersion-type filtration module including hollow fiber membranes having a high filtration performance has been proposed (Japanese Unexamined Patent Application Publication No. 2010-253397). With the progress of filtration, the surfaces of the hollow fiber membranes are contaminated due to, for example, attachment of substances contained in a liquid to be treated, and thus the filtration performance of the filtration device decreases unless any treatment is performed. Therefore, in the filtration device, a cleaning method (air-scrubbing) for removing an attached substance is performed in which bubbles are sent from below the immersion-type filtration module so as to scrub the surfaces of the hollow fiber membranes and to further vibrate the hollow fiber membranes.

On the other hand, in order to activate a filtration action of aerobic microorganisms, it is necessary to dissolve a certain amount of oxygen in the liquid to be treated. For this purpose, a gas supply unit (aeration equipment) for supplying oxygen into the filtration tank is separately provided in the filtration device.

### CITATION LIST

### Patent Literature

PTL 1: Japanese Unexamined Patent Application Publication No. 2010-253397

### SUMMARY OF INVENTION

### Technical Problem

A gas supplied to a filtration tank of a filtration device includes a gas for cleaning an immersion-type filtration module and a gas for supplying oxygen, as described above. The filtration cost can be reduced by reducing the amounts of these gases supplied. Of these, reducing the supply of the oxygen supply gas, whose supplied amount is large, is effective for reducing the filtration cost. However, in existing filtration devices, there have not been sufficient studies on the reduction in the amount of oxygen supply gas to be supplied, and there is a room for improvement in the reduction in the operating cost of the filtration device.

The present invention has been made on the basis of the circumstances described above. An object of the present invention is to provide a filtration device in which the filtration cost can be reduced by improving a dissolution efficiency of oxygen in a filtration tank, and a filtration method using the filtration device.

### Solution to Problem

An invention made in order to solve the above problem is a filtration device comprising a filtration tank that stores a liquid to be treated, the liquid containing a microorganism; an immersion-type filtration module that is disposed in the filtration tank and that includes a plurality of separation membranes; and a first gas supply unit that generates bubbles for cleaning the separation membranes from below the immersion-type filtration module,

in which the filtration device further includes a second gas supply unit that is arranged in a lower portion of the filtration tank so as to be spaced apart from the first gas supply unit and that generates bubbles for supplying oxygen, and

a bubble-rising prevention zone is formed above the second gas supply unit by the generation of the bubbles from the first gas supply unit.

Another invention made in order to solve the above problem is
a filtration method using the filtration device.

### Advantageous Effects of Invention

According to the filtration device and the filtration method of the present invention, the amount of gas supplied can be reduced by efficiently dissolving oxygen in a filtration tank. That is, the filtration device and the filtration method of the present invention can reduce the filtration cost and can be suitably used in an activated sludge treatment.

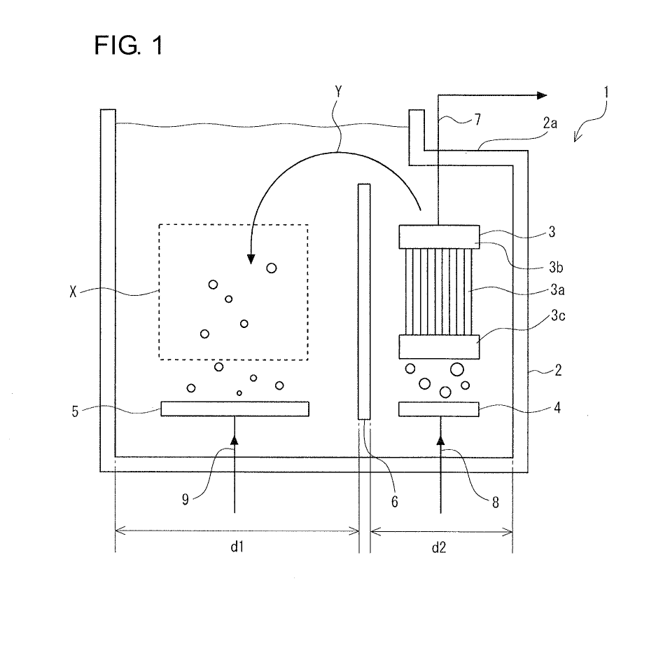

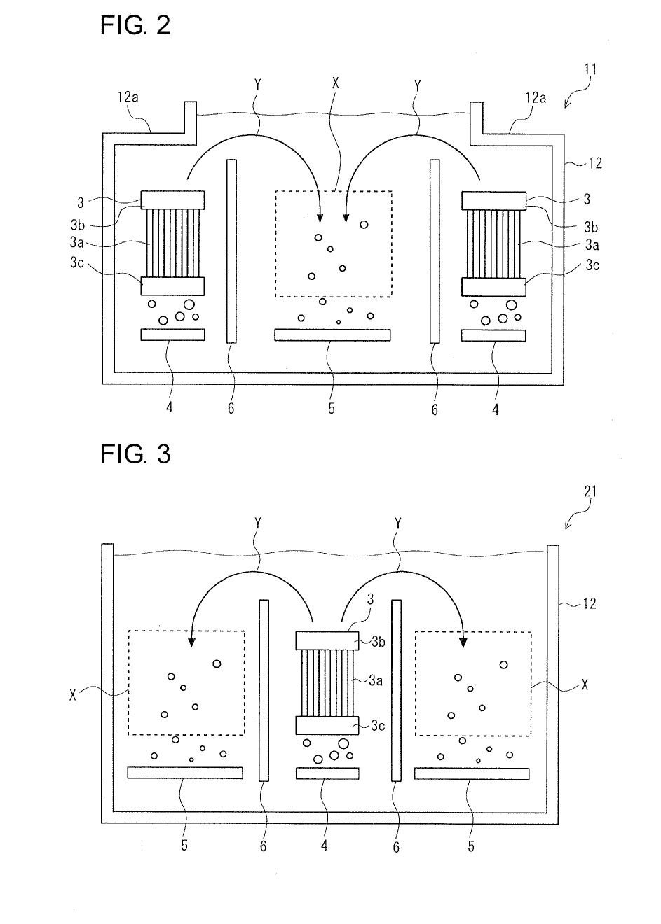

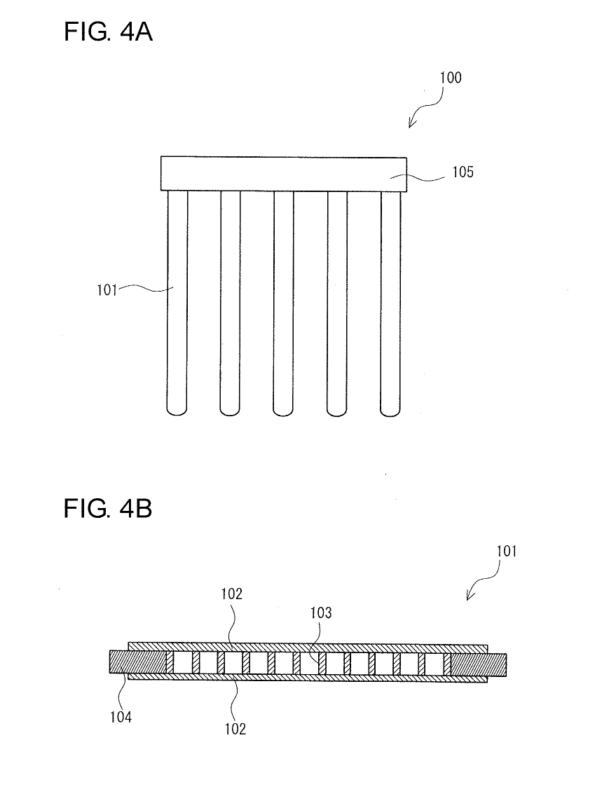

### BRIEF DESCRIPTION OF DRAWINGS

[FIG. 1] FIG. 1 is a schematic view illustrating a filtration device according to an embodiment of the present invention.

[FIG. 2] FIG. 2 is a schematic view illustrating a filtration device according town embodiment different from the filtration device illustrated in FIG. 1.

[FIG. 3] FIG. 3 is a schematic view illustrating a filtration device according to an embodiment different from the filtration devices illustrated in FIGS. 1 and 2.

[FIG. 4A] FIG. 4A is a schematic view illustrating an immersion-type filtration module according to an embodiment different from the immersion-type filtration module illustrated in FIG. 1.

[FIG. 4B] FIG. 4B is a schematic cross-sectional view illustrating a flat membrane element included in the immersion-type filtration module illustrated in FIG. 4A.

### REFERENCE SIGNS LIST

1, 11, 21 filtration device
2, 12 filtration tank
2a, 12a top surface
3 immersion-type filtration module
3a hollow fiber membrane
3b upper holding member
3c lower holding member
4 first gas supply unit
5 second gas supply unit
6 partition plate
7 discharge pipe
8, 9 gas supply pipe
100 immersion-type filtration module
101 flat membrane element
102 filtration membrane
103 support
104 outer periphery sealing portion
105 header
X bubble-rising prevention zone
Y circumfluence
d1 width of space including bubble-rising prevention zone X
d2 width of space including immersion-type filtration module 3
Description of Embodiments

### DESCRIPTION OF EMBODIMENTS OF PRESENT INVENTION

The present invention provides

a filtration device comprising a filtration tank that stores a liquid to be treated, the liquid containing a microorganism; an immersion-type filtration module that is disposed in the filtration tank and that includes a plurality of separation membranes; and a first gas supply unit that generates bubbles for cleaning the separation membranes from below the immersion-type filtration module,

in which the filtration device further includes a second gas supply unit that is arranged in a lower portion of the filtration tank so as to be spaced apart from the first gas supply unit and that generates bubbles for supplying oxygen, and

a bubble-rising prevention zone is formed above the second gas supply unit by the generation of the bubbles from the first gas supply unit.

Since the filtration device forms a bubble-rising prevention zone above the second gas supply unit as a result of the generation of the bubbles from the first gas supply unit, a rising speed of the bubbles for supplying oxygen, the bubbles being generated from the second gas supply unit, easily decreases in this bubble-rising prevention zone. As a result, the time until the bubbles for supplying oxygen reach an upper surface of the filtration tank increases to increase the amount of oxygen that can be dissolved by one bubble in the liquid to be treated in the filtration tank, and thus oxygen can be supplied efficiently. With this structure, the filtration device can reduce the filtration cost.

A downflow of the liquid to be treated is preferably present in the bubble-rising prevention zone. When a downflow is present in the bubble-rising prevention zone in this manner, rising of the bubbles generated from the second gas supply unit is suppressed, and an oxygen supply efficiency of the filtration device can be reliably improved.

A turbulence flow of the liquid to be treated may be present in the bubble-rising prevention zone. When a turbulence flow is present in the bubble-rising prevention zone in this manner, the bubbles generated from the second gas supply unit are allowed to flow downward and in the horizontal direction by the turbulence flow and rising of the bubbles is suppressed. Accordingly, an oxygen supply efficiency of the filtration device can be reliably improved.

The filtration tank preferably has a top surface that covers at least a part of the immersion-type filtration module in top view. By providing a top surface that covers at least a part above the immersion-type filtration module in this manner, bubbles for cleaning the separation membranes, the bubbles being generated from the first gas supply unit, rise and, with the bubbles approach the top surface, the bubbles flow easily to the second gas supply unit side. Accordingly, a circumfluence in which the liquid to be treated moves from the first gas supply unit side to the second gas supply unit side can be more reliably formed. As a result, a downflow or a turbulence flow of the liquid to be treated is more reliably generated above the second gas supply unit. Thus, the bubble-rising prevention zone can be more stably formed above the second gas supply unit.

The filtration device preferably further includes a partition portion disposed between the bubble-rising prevention zone and the immersion-type filtration module. By disposing a partition portion between the bubble-rising prevention zone and the immersion-type filtration module in this manner, it is possible to prevent the downflow or the turbulence flow of the liquid to be treated, the downflow or the turbulence flow being generated by jetting of bubbles from the first gas supply unit, from dispersing to the immersion-type filtration module side, and to form a more stable bubble-rising prevention zone.

An average horizontal diameter of the bubbles generated from the first gas supply unit is preferably larger than an average horizontal diameter of the bubbles generated from the second gas supply unit. By controlling an average horizontal diameter of the bubbles generated from the first gas supply unit to be larger than an average horizontal diameter of the bubbles generated from the second gas supply unit in this manner, the rising speed of the bubbles from the first gas supply unit is made higher than the rising speed of the bubbles from the second gas supply unit, and a downflow or a turbulence flow of the liquid to be treated can be more reliably generated above the second gas supply unit. Note that the term “average horizontal diameter of bubbles” means an average of minimum widths of bubbles in the horizontal direction, the bubbles immediately, after being discharged from a gas supply unit.

### DETAILS OF EMBODIMENTS OF PRESENT INVENTION

A filtration device according to an embodiment of the present invention will now be described in detail with reference to the drawings.

A filtration device 1 illustrated in FIG. 1 includes a filtration tank 2 that stores a liquid to be treated, the liquid containing a microorganism, an immersion-type filtration module 3 that is disposed in the filtration tank 2 and that includes a plurality of hollow fiber membranes, a first gas supply unit 4 that generates bubbles for cleaning the hollow fiber membranes from below the immersion-type filtration module 3, and a second gas supply unit 5 that generates bubbles for supplying oxygen and that is arranged in a lower portion of the filtration tank 2 so as to be spaced apart from the first gas supply unit 4. The filtration device 1 generates, above the second gas supply unit 5, a downflow or a turbulence flow of the liquid to be treated as a result of the generation of the bubbles from the first gas supply unit 4 and forms a bubble-rising prevention zone X above the second gas supply unit 5. Furthermore, the filtration device 1 includes a partition plate 6 functioning as a partition portion disposed between the bubble-rising prevention zone X and the immersion-type filtration module 3.

<Filtration Tank 2>

The filtration tank 2 is a water tank that stores a liquid to be treated. From the liquid to be treated, the liquid being supplied to the filtration tank 2, organic substances are removed by the activity of microorganisms in the filtration tank 2. Subsequently, the liquid is further filtered by the immersion-type filtration module 3 and collected as a treated liquid.

Aerobic microorganisms are contained in the liquid to be treated in the filtration tank 2. Herein, the term “aerobic microorganisms” generically means organisms that use oxygen. In addition to obligate aerobic microorganisms, facultative anaerobic microorganisms and microaerophilic microorganisms may be contained. The microorganisms may be present in the filtration tank 2 in a dispersed manner. However, in order to further enhance the effect of the present invention, a plurality of microorganisms are preferably attached to a membrane-shaped support (hereinafter referred to as “membrane support”), and the membrane support is preferably arranged in a bubble-rising prevention zone X described below.

The structure of the membrane support is not particularly limited as long as a plurality of microorganisms can be attached and maintained. For example, the membrane support may be a porous film having a plurality of pores. The material of the membrane support is not particularly limited. However, polytetrafluoroethylene (PTFE) is preferably used from the viewpoint of the strength, chemical resistance, ease of pore formation, etc. Microorganisms may be attached to the membrane support using a flocculating agent.

The membrane support may be fixed in the filtration tank 2 or arranged so as to swing or flow in the filtration tank 2. The membrane support is preferably fixed in the bubble-rising prevention zone X so that oxygen can be supplied reliably and efficiently by bubbles generated from the second gas supply unit 5.

The microorganisms may be supplied into the filtration tank 2 or the membrane support, as required, through a microorganism addition tank or a microorganism addition pipe (not shown). The filtration device 1 may include a device that observes the number of microorganisms in the filtration tank 2 by, for example, photographing and that automatically supplies microorganisms when the number of microorganisms becomes a particular value or less.

The dimensions of the filtration tank 2 are not particularly limited. For example, the filtration tank 2 may have a width (in the left-right direction of the drawing) of 4 m or more and 7 m or less, a depth (in the top-bottom direction of the drawing) of 4 m or more and 6 m or less, and a length (in a direction perpendicular to the paper surface of the drawing) of 4 m or more and 30 m or less.

The filtration tank 2 has a top surface 2a that covers the immersion-type filtration module 3 in top view. The liquid to be treated is stored so that the liquid level is higher than the top surface 2a. Due to the presence of the top surface 2a, bubbles generated from the first gas supply unit 4 described below are allowed to flow to the bubble-rising prevention zone X side (the second gas supply unit 5 side) with the bubbles rise, and a circumfluence Y of the liquid to be treated, which will be described below, is easily generated.

<Immersion-Type Filtration Module>

The immersion-type filtration module 3 is arranged at a position close to one side (side face) of the filtration tank 2 in the width direction. The immersion-type filtration module 3 includes a plurality of hollow fiber membranes 3a aligned in the vertical direction, and an upper holding member 3b and a lower holding member 3c that fix the hollow fiber membranes 3a in position in the vertical direction.

(Hollow Fiber Membrane)

The hollow fiber membranes 3a are each a porous hollow fiber membrane that allows water to permeate into an inner hollow part but blocks permeation of particles contained in a liquid to be treated.

The material that forms the hollow fiber membranes 3a may contain a thermoplastic resin as a main component. Examples of the thermoplastic resin include polyethylene, polypropylene, polyvinylidene fluoride, ethylene-vinyl alcohol copolymers, polyamide, polyimide, polyetherimide, polystyrene, polysulfone, polyvinyl alcohol, polyphenylene ether, polyphenylene sulfide, acetylcellulose, polyacrylonitrile, and polytetrafluoroethylene (PTFE). Among these, PTFE which can be made to be porous and which has good chemical resistance, good heat resistance, good weather resistance, good flame resistance, etc. is preferable as the material that forms the hollow fiber membranes 3a. Uniaxially or biaxially stretched PTFE is more preferable as the material that forms the hollow fiber membranes 3a. If necessary, other polymers, additives such as a lubricant, etc. may be blended in the material that forms the hollow fiber membranes 3a.

The hollow fiber membranes 3a each preferably have a multilayer structure in order to realize both permeability and mechanical strength and to achieve a more significant effect of surface cleaning with bubbles. Specifically, the hollow fiber membranes 3a each preferably include an inner support layer and a filtration layer covering a surface of the support layer.

For example, a tube obtained by extrusion-molding a thermoplastic resin may be used as the support layer. By using an extrusion-molded tube as the support layer in this manner, the support layer can be provided with mechanical strength, and pores can also be easily formed. This tube is preferably stretched at a stretching ratio of 50% or more and 700% or less in the axial direction and at a stretching ratio of 5% or more and 100% or less in the circumferential direction.

The temperature during the stretching is preferably equal to or lower than a melting point of the tube raw material, for example, about 0° C. to 300° C. Stretching at a low temperature is suitable in order to obtain a porous body having a relatively large pore diameter. Stretching at a high temperature is suitable in order to obtain a porous body having a relatively small pore diameter. The stretched porous body may be heat-treated at a temperature of 200° C. to 300° C. for about 1 to 30 minutes while both ends thereof are fixed to maintain the stretched state, thereby obtaining high dimensional stability. The size of the pores of the porous body can be adjusted by combining conditions of the stretching temperature, the stretching ratio, and the like.

In the case where PTFE is used as the material that forms the support layer, the tube that forms the support layer can be obtained by, for example, blending a liquid lubricant such as naphtha with a PTFE fine powder, forming a tube by extrusion molding or the like, and then stretching the tube. In addition, the tube may be sintered by holding in a heating furnace in which the temperature is maintained at a temperature equal to or higher than a melting point of the PTFE fine powder, for example, about 350° C. to 550° C. for about several tens of seconds to several minutes, thereby increasing dimensional stability.

The lower limit of the number-average molecular weight of the PTFE fine powder is preferably 500,000, and more preferably 2,000,000. When the number-average molecular weight of the PTFE fine powder is less than the lower limit, the surfaces of the hollow fiber membranes 3a may be damaged by scrubbing with bubbles, or the mechanical strength of the hollow fiber membranes 3a may decrease. On the other hand, the upper limit of the number-average molecular weight of the PTFE fine powder is preferably 20,000,000. When the number-average molecular weight of the PTFE fine powder exceeds the upper limit, it may become difficult to form pores of the hollow fiber membranes 3a. Note that the number-average molecular weight is a value measured by gel permeation chromatography.

An average thickness of the support layer is preferably 0.1 mm or more and 3 mm or less. By controlling the average thickness of the support layer in the above range, the hollow fiber membranes 3a can be provided with mechanical strength and permeability with a good balance.

The filtration layer can be formed by, for example, winding a thermoplastic resin sheet around the support layer, and performing sintering. By using a sheet as a material that forms the filtration layer in this manner, stretching can be easily performed, the shape and the size of the pores can be easily adjusted, and the thickness of the filtration layer can be reduced. Furthermore, by winding a sheet and then performing sintering, the support layer is integrated with the filtration layer, and pores of these layers are communicated with one another to improve permeability. This sintering temperature is preferably equal to or higher than melting points of the tube that forms the support layer and the sheet that forms the filtration layer.

The sheet that forms the filtration layer can be prepared by, for example, (1) a method in which an unsintered molded body obtained by extruding a resin is stretched at a temperature equal to or lower than a melting point, and then sintered, or (2) a method in which a sintered resin molded body is cooled slowly to increase the degree of crystallinity, and then stretched. This sheet is preferably stretched at a stretching ratio of 50% or more and 1,000% or less in the longitudinal direction and at a stretching ratio of 50% or more and 2,500% or less in the transverse direction. In particular, by controlling the stretching ratio in the transverse direction in the above range, mechanical strength in the circumferential direction can be improved when the sheet is wound, and durability to the surface cleaning with bubbles can be improved.

In the case where the filtration layer is formed by winding a sheet around a tube that forms the support layer, fine irregularities are preferably provided on the outer circumferential surface of the tube. By providing irregularities on the outer circumferential surface of the tube in this manner, misalignment of the tube and the sheet can be prevented, and adhesiveness between the tube and the sheet can be improved. Thus, detachment of the filtration layer from the support layer due to cleaning with bubbles can be prevented. The number of windings of the sheet may be adjusted depending on the thickness of the sheet and may be one or two or more. Alternatively, a plurality of sheets may be wound around a tube. The method for winding a sheet is not particularly limited. Examples of the method that may be used include a method in which a sheet is wound in a circumferential direction of a tube, and a method in which a sheet is wound around a tube in a spiral manner.

The size (difference in height) of the fine irregularities is preferably 20 μm or more and 200 μm or less. The fine irregularities are preferably formed over the entire outer circumferential surface of the tube. However, the fine irregularities may be formed partly or intermittently. Examples of the method for forming the fine irregularities on the outer circumferential surface of the tube include a surface treatment with a flame, laser irradiation, plasma irradiation, and coating of a dispersion containing a fluororesin or the like. A surface treatment with a flame is preferable because irregularities can be easily formed without affecting tube properties.

Alternatively, an unsintered tube and an unsintered sheet may be used. The sheet may be wound around the tube, and sintering may then be performed. Thus, adhesiveness between the tube and the sheet may be increased.

An average thickness of the filtration layer is preferably 5 μm or more and 100 μm or less. By controlling the average thickness of the filtration layer in the above range, the hollow fiber membranes 3a can be provided with a high filtration performance easily and reliably.

The upper limit of an average outer diameter of the hollow fiber membranes 3a is preferably 6 mm, and more preferably 4 mm. When the average outer diameter of the hollow fiber membranes 3a exceeds the upper limit, a ratio of the surface area to the cross-sectional area of the hollow fiber membranes 3a is small and the filtration efficiency may decrease. On the other hand, the lower limit of the average outer diameter of the hollow fiber membranes 3a is preferably 2 mm, and more preferably 2.1 mm. When the average outer diameter of the hollow fiber membranes 3a is less than the lower limit, the mechanical strength of the hollow fiber membranes 3a may be insufficient.

The upper limit of an average inner diameter of the hollow fiber membranes 3a is preferably 4 mm, and more preferably 3 mm. When the average inner diameter of the hollow fiber membranes 3a exceeds the upper limit, the thicknesses of the hollow fiber membranes 3a are small, and the mechanical strength and the effect of blocking permeation of impurities may be insufficient. On the other hand, the lower limit of the average inner diameter of the hollow fiber membranes 3a is preferably 0.5 mm, and more preferably 0.9 mm. When the average inner diameter of the hollow fiber membranes 3a is less than the lower limit, a pressure loss may increase when a filtered liquid in the hollow fiber membranes 3a is discharged.

The upper limit of a ratio of the average inner diameter to the average outer diameter of the hollow fiber membranes 3a is preferably 0.8 and more preferably 0.6. When the ratio of the average inner diameter to the average outer diameter of the hollow fiber membranes 3a exceeds the upper limit, the thicknesses of the hollow fiber membranes 3a decrease, and the mechanical strength of the hollow fiber membranes 3a, the effect of blocking permeation of impurities, and durability to the surface cleaning with bubbles may be insufficient. On the other hand, the lower limit of the ratio of the average inner diameter to the average outer diameter of the hollow fiber membranes 3a is preferably 0.3 and more preferably 0.4. When the ratio of the average inner diameter to the average outer diameter of the hollow fiber membranes 3a is less than the lower limit, the thicknesses of the hollow fiber membranes 3a are excessively large, and permeability of the hollow fiber membranes 3a may decrease.

An average length of the hollow fiber membranes 3a is not particularly limited, and is, for example, 1 m or more and 3 m or less. The term “average length of the hollow fiber membranes 3a” means an average distance from an upper end fixed to the upper holding member 3b to a lower end fixed to the lower holding member 3c. In the case where one hollow fiber membrane 3a is curved in a U-shape, and the curved portion that forms a lower end is fixed with the lower holding member 3c as described below, the term “average length” means an average distance from this lower end to an upper end (opening portion).

The upper limit of a porosity of the hollow fiber membranes 3a is preferably 90%, and more preferably 85%.
When the porosity of the hollow fiber membranes 3a exceeds the upper limit, the mechanical strength and scrub resistance of the hollow fiber membranes 3a may be insufficient. On the other hand, the lower limit of the porosity of the hollow fiber membranes 3a is preferably 75%, and more preferably 78%. When the porosity of the hollow fiber membranes 3a is less than the lower limit, permeability decreases, and the filtration performance of the filtration device 1 may decrease. The term “porosity” means a ratio of the total volume of pores to the volume of a hollow fiber membrane 3a. The porosity can be determined by measuring the density of the hollow fiber membrane 3a in accordance with ASTM-D-792.

The upper limit of an area occupancy ratio of pores of the hollow fiber membranes 3a is preferably 60%. When the area occupancy ratio of pores exceeds the upper limit, a surface strength of the hollow fiber membranes 3a may be insufficient, and, for example, the hollow fiber membranes 3a may be damaged by scrubbing with bubbles. On the other hand, the lower limit of the area occupancy ratio of pores of the hollow fiber membranes 3a is preferably 40%. When the area occupancy ratio of pores is less than the lower limit, permeability of the hollow fiber membranes 3a decreases, and the filtration performance of the filtration device 1 may decrease. The term “area occupancy ratio of pores” means a ratio of the total area of pores in an outer circumferential surface (filtration layer surface) of a hollow fiber membrane 3a to the surface area of the hollow fiber membrane 3a. The area occupancy ratio of pores can be determined by analyzing an electron micrograph of the outer circumferential surface of the hollow fiber membrane 3a.

The upper limit of an average diameter of pores of the hollow fiber membranes 3a is preferably 0.45 μm, and more preferably 0.1 μm. When the average diameter of pores of the hollow fiber membranes 3a exceeds the upper limit, permeation of impurities into the hollow fiber membranes 3a, the impurities being contained in a liquid to be treated, may not be blocked. On the other hand, the lower limit of the average diameter of pores of the hollow fiber membranes 3a is preferably 0.01 μm. When the average diameter of pores of the hollow fiber membranes 3a is less than the lower limit, permeability of the hollow fiber membranes 3a may decrease. The term “average diameter of pores” means an average diameter of pores in an outer circumferential surface (filtration layer surface) of a hollow fiber membrane 3a. The average diameter of pores can be measured with a pore size distribution measuring device (for example, a porous material automatic pore size distribution measuring system, manufactured by Porus Materials, Inc.).

(Upper Holding Member and Lower Holding Member)

The upper holding member 3b is a member that holds upper ends of a plurality of hollow fiber membranes 3a. The upper holding member 3b communicates with upper openings of the hollow fiber membranes 3a and includes a discharge portion (water collection header) that collects a filtered liquid. A discharge pipe 7 is connected to the discharge portion, and the filtered liquid that permeates inside the hollow fiber membranes 3a is discharged. The outer shape of the upper holding member 3b is not particularly limited. The cross-sectional shape of the upper holding member 3b may be a polygonal shape, a circular shape, or the like.

The lower holding member 3c is a member that holds lower ends of the plurality of hollow fiber membranes 3a. For example, a member in which a plurality of rod-shaped fixing parts are disposed in parallel or substantially parallel at certain intervals may be used as the lower holding member 3c. A plurality of hollow fiber membranes 3a are disposed on each of the upper sides of the fixing parts.

Two ends of a hollow fiber membrane 3a may be respectively fixed with the upper holding member 3b and the lower holding member 3c. Alternatively, one hollow fiber membrane 3a may be curved in a U-shape, two opening portions thereof may be fixed with the upper holding member 3b, and the lower-end folded (curved) portion may be fixed with the lower holding member 3c.

The material of the upper holding member 3b and the lower holding member 3c is not particularly limited. For example, an epoxy resin, an acrylonitrile-butadiene-styrene (ABS) resin, a silicone resin, or the like may be used.

The method for fixing the hollow fiber membranes 3a to the upper holding member 3b and the lower holding member 3c is not particularly limited. For example, a fixing method using an adhesive may be used.

In order to facilitate handling (transportation, installation, exchange, etc.) of the immersion-type filtration module 3, the upper holding member 3b and the lower holding member 3c are preferably connected to each other with a connecting member. For example, a metal supporting rod, a resin casing (external cylinder), or the like may be used as the connecting member.

<First Gas Supply Unit>

The first gas supply unit 4 generates bubbles that clean the surfaces of the hollow fiber membranes 3a from below the immersion-type filtration module 3. The bubbles conduct cleaning by scrubbing the surfaces of the hollow fiber membranes 3a. An average horizontal diameter of the bubbles is preferably larger than an average horizontal diameter of bubbles produced by the second gas supply unit 5 described below. A jetting pressure of the bubbles generated from the first gas supply unit 4 forms a circumfluence Y, which moves from above the first gas supply unit 4 to above the second gas supply unit 5 and further forms, above the second gas supply unit 5, a downflow or a turbulence flow of a liquid to be treated.

The first gas supply unit 4 is immersed together with the immersion-type filtration module 3 in the liquid to be treated. The first gas supply unit 4 discharges a gas supplied from a compressor or the like through a gas supply pipe 8, thereby generating bubbles. Examples of the first gas supply unit 4 include aeration equipment that uses a porous plate or a porous pipe obtained by forming a large number of pores in a plate or pipe composed of a resin or a ceramic, jet flow-type aeration equipment that jets a gas from a diffuser, a sparger, or the like, and intermittent bubble-jetting aeration equipment that intermittently jets bubbles. Among these, aeration equipment that can continuously jet bubbles from a plurality of discharge openings is preferable from the viewpoint of the ease of the formation of the bubble-rising prevention zone X.

<Second Gas Supply Unit>

The second gas supply unit 5 is arranged in a lower portion of the filtration tank 2 so as to be spaced apart from the first gas supply unit 4 and generates bubbles for supplying oxygen into the filtration tank 2. A rising speed of the bubbles is preferably lower than a rising speed of bubbles produced by the first gas supply unit 4.

Similarly to the first gas supply unit 4, the second gas supply unit 5 is immersed in the liquid to be treated and discharges a gas supplied from a compressor or the like through a gas supply pipe 9, thereby generating bubbles. The gas supply pipe 8 of the first gas supply unit 4 and the gas supply pipe 9 of the second gas supply unit 5 may be connected to the same gas supply unit.

Equipment that is similar to the first gas supply unit 4 may be used as the second gas supply unit 5.

The amount of air supplied from the second gas supply unit 5 is preferably adjusted, as required, by using, for example, means for monitoring the active state of microorganisms. For example, a dissolved oxygen (DO) concentration meter may be used as the monitoring means.

The gas supplied from the first gas supply unit 4 is not particularly limited as long as the gas is inert. The gas supplied from the second gas supply unit 5 is not particularly limited as long as the gas contains oxygen. However, from the viewpoint of the operating cost, air is preferably used as each of the gases.

<Partition Plate>

The partition plate 6 is a plate-like body disposed between the bubble-rising prevention zone X and the immersion-type filtration module 3. Specifically, a lower end of the partition plate 6 is located below bubble-discharge openings of the first gas supply unit 4 and the second gas supply unit 5, and an upper end of the partition plate 6 is located above the upper holding member 3b of the immersion-type filtration module 3. Spaces through which the liquid to be treated can communicate are formed above and below the partition plate 6. This partition plate 6 prevents bubbles generated from the first gas supply unit 4 from moving to above the second gas supply unit 5 during the rising of the bubbles. With this structure, the bubbles generated from the first gas supply unit 4 can move to above the second gas supply unit 5 only after reaching the upper end of the partition plate 6. Accordingly, the circumfluence Y of the liquid to be treated is generated more reliably to easily form the bubble-rising prevention zone X. A length of the partition plate 6 (in a direction perpendicular to the paper surface of the drawing) is not particularly limited as long as a space above the first gas supply unit 4 and a space above the second gas supply unit 5 can be separated from each other.

In spaces sandwiched between the partition plate 6 and each of the side faces of the filtration tank 2, the side faces facing the partition plate 6, the upper limit of a ratio (d2/d1) determined by dividing a width d2 of a space including the immersion-type filtration module 3 (distance from the partition plate 6 to one of the side faces of the filtration tank 2) by a width d1 of a space including the bubble-rising prevention zone X (distance from the partition plate 6 to the other side face of the filtration tank 2) is preferably 1.0, and more preferably 0.8. When the ratio (d2/d1) exceeds the upper limit, the pressure caused by the generation of bubbles from the first gas supply unit 4 disperses, and the circumfluence Y of the liquid to be treated is not easily generated. Consequently, the bubble-rising prevention zone X may not be stably formed. On the other hand, the lower limit of the ratio (d2/d1) is preferably 0.3, and more preferably 0.5. When the ratio (d2/d1) is less than the lower limit, the size of the immersion-type filtration module 3 is limited, and the treatment capacity of the filtration device 1 may decrease.

The upper limit of the distance between the lower end of the partition plate 6 and the bottom surface of the filtration tank 2 is preferably 50 cm, and more preferably 30 cm. When the distance between the lower end of the partition plate 6 and the bottom surface of the filtration tank 2 exceeds the upper limit, the effect of guiding bubbles generated from the first gas supply unit 4, the effect being obtained by the partition plate 6, may be insufficient. On the other hand, the lower limit of the distance between the lower end of the partition plate 6 and the bottom surface of the filtration tank 2 is preferably 5 cm, and more preferably 10 cm. When the distance between the lower end of the partition plate 6 and the bottom surface of the filtration tank 2 is less than the lower limit, the circumfluence of the liquid to be treated is not easily generated in the filtration tank 2, and the bubble-rising prevention zone X may not be formed.

The upper limit of the distance between the upper end of the partition plate 6 and the liquid level of the filtration tank 2 at the stationary time is preferably 50 cm, and more preferably 30 cm. When the distance between the upper end of the partition plate 6 and the liquid level of the filtration tank 2 at the stationary time exceeds the upper limit, the effect of guiding bubbles generated from the first gas supply unit 4, the effect being obtained by the partition plate 6, may be insufficient. On the other hand, the lower limit of the distance between the upper end of the partition plate 6 and the liquid level of the filtration tank 2 at the stationary time is preferably 5 cm, and more preferably 10 cm. When the distance between the upper end of the partition plate 6 and the liquid level of the filtration tank 2 at the stationary time is less than the lower limit, the circumfluence is not easily generated in the filtration tank 2, and the bubble-rising prevention zone X may not be formed.

<Bubble-Rising Prevention Zone>

The bubble-rising prevention zone X is formed above the second gas supply unit 5 by the circumfluence Y of the liquid to be treated, the circumfluence Y being generated by the pressure of generation of bubbles from the first gas supply unit 4. More specifically, a water flow generated as a result of jetting of bubbles produced by the first gas supply unit 4 and rising of the bubbles moves toward the second gas supply unit 5 side in an upper portion of the filtration tank 2 and generates the circumfluence Y of the liquid to be treated. This circumfluence Y forms, above the second gas supply unit 5, a downflow or a turbulence flow of the liquid to be treated. Consequently, rising of the bubbles generated from the second gas supply unit 5 is prevented by the downflow or the turbulence flow, thus suppressing the rising speed of the bubbles.

<Method of Use>

The filtration device 1 can be used in a continuous system in which a liquid to be treated is continuously supplied to the filtration tank 2 or a batch system in which a liquid to be treated is intermittently supplied to the filtration tank 2 at predetermined time intervals.

<Advantages>

The filtration device 1 forms the bubble-rising prevention zone X above the second gas supply unit 5 as a result of the generation of bubbles from the first gas supply unit 4. Therefore, the rising speed of bubbles for supplying oxygen, the bubbles being generated from the second gas supply unit 5, easily decreases in the bubble-rising prevention zone X. As a result, the time until the bubbles for supplying oxygen reach the upper surface of the filtration tank 2 increases to increase the amount of oxygen that can be dissolved by one bubble in the liquid to be treated in the filtration tank 2, and thus oxygen can be supplied efficiently. With this structure, the filtration device 1 can reduce the filtration cost.

Furthermore, in the filtration device 1, the rising speed of the bubbles generated from the first gas supply unit 4 is increased by the circumfluence Y of the liquid to be treated. Accordingly, the scrubbing pressure on the hollow fiber membranes 3a increases, and the effect of cleaning the hollow fiber membranes 3a can be improved.

<Filtration Method>

According to a filtration method using the filtration device 1, since the amount of bubbles for supplying oxygen to microorganisms can be decreased as described above, the filtration cost can be reduced.

### OTHER EMBODIMENTS

It is to be understood that the embodiments disclosed herein are only illustrative and are not restrictive in all respects. The scope of the present invention is not limited to the configurations of the above embodiments but is defined by the claims described below. It is intended that the scope of the present invention includes equivalents of the claims and all modifications within the scope of the claims.

The filtration device may include a plurality of immersion-type filtration modules 3, as illustrated in a filtration device 11 in FIG. 2. In the filtration device 11, an immersion-type filtration module 3 is arranged on each of two lateral sides in a filtration tank 12. A first gas supply unit 4 is disposed below each of the immersion-type filtration modules 3. A bubble-rising prevention zone X is formed between the two immersion-type filtration modules 3 and above a second gas supply unit 5. A partition plate 6 is disposed between the bubble-rising prevention zone X and each of the immersion-type filtration modules 3. Furthermore, the filtration tank 12 has a top surface 12a that covers each of the immersion-type filtration modules 3 in top view.

As in the filtration device 1 illustrated in FIG. 1, in the filtration device 11 illustrated in FIG. 2, a water flow of a liquid to be treated, the water flow being generated as a result of jetting of bubbles produced by the two first gas supply units 4 and rising of the bubbles, moves toward the second gas supply unit 5 side in an upper portion of a filtration tank 12 and generates a circumfluence Y of the liquid to be treated. This circumfluence Y forms, above the second gas supply unit 5, a downflow or a turbulence flow of the liquid to be treated. Consequently, the bubble-rising prevention zone X is formed in which the rising speed of bubbles generated from the second gas supply unit 5 is decreased by the downflow or the turbulence flow. With this structure, the amount of oxygen that can be dissolved in the liquid to be treated in the filtration tank 12 by one bubble generated from the second gas supply unit 5 increases, and thus the filtration device 11 can efficiently supply oxygen to microorganisms.

Furthermore, as illustrated in a filtration device 21 in FIG. 3, the filtration device may include an immersion-type filtration module 3 disposed at the center of a filtration tank 12, and second gas supply units 5 disposed so that two bubble-rising prevention zones X are formed on both sides of the immersion-type filtration module 3. Specifically, in the filtration device 21, a second gas supply unit 5 is arranged in a lower portion of each of two lateral sides of the filtration tank 12. A bubble-rising prevention zone X is formed above each of the second gas supply units 5. A partition plate 6 is disposed between the immersion-type filtration module 3 and each of the bubble-rising prevention zones X.

Similarly to the filtration devices illustrated in FIGS. 1 and 2, in the filtration device 21 illustrated in FIG. 3, a water flow generated as a result of jetting of bubbles produced by the first gas supply unit 4 and rising of the bubbles moves toward each of the lateral second gas supply unit 5 sides in upper portions of the filtration tank 12 and generates circumfluences Y of the liquid to be treated. Each of the circumfluences Y forms, above the corresponding second gas supply unit 5, a downflow or a turbulence flow of the liquid to be treated. Consequently, the bubble-rising prevention zones X are formed in which the rising speed of bubbles generated from the corresponding second gas supply unit 5 is decreased by the downflow or the turbulence flow. This structure increases the amount of oxygen that can be dissolved in the liquid to be treated in the filtration tank 12 by one bubble generated from each of the second gas supply units 5. Accordingly, the filtration device 21 can efficiently supply oxygen to microorganisms. In the filtration device 21, the filtration tank 12 may have a top surface that covers the immersion-type filtration module 3 in top view.

The separation membrane of the immersion-type filtration module included in the filtration device is not particularly limited as long as water and particles contained in a liquid to be treated can be separated from each other. In the above embodiments, an immersion-type filtration module including hollow fiber membranes as the separation membrane is used. In the filtration device, for example, an immersion-type filtration module 100 in which flat membrane elements 101 illustrated in FIG. 4A are collected as the separation membrane may also be used. As illustrated in FIG. 4B, the flat membrane elements 101 each include a filtration membrane 102 formed of a resin sheet such as porous PTFE and folded so that surfaces on one side face each other, a support 103 formed of a resin net such as polyethylene and interposed between the facing surfaces of the filtration membrane 102, and an outer periphery sealing portion 104 that seals an outer periphery of the filtration membrane 102 in the folded state. The filtration membrane 102 is arranged so that a folded portion thereof is located on the lower side and the opening portion thereof is fixed to a header 105. As a result, a treated liquid flow path is formed inside the flat membrane element 101.

The filtration membrane 102 may include a single layer or multiple layers. The filtration membrane 102 preferably has pores of 0.01 to 20 μm. In the filtration membrane 102, a particle trapping rate of particles having a diameter of 0.45 μm is preferably 90% or more. The filtration membrane 102 preferably has an average membrane thickness of 5 to 200 μm. In the filtration membrane 102, an average maximum length of a fibrous skeleton that surrounds a pore is preferably 5 μm or less.

Furthermore, the partition portion disposed between the bubble-rising prevention zone and the immersion-type filtration module is not limited to the partition plate as long as the circulation of a liquid flow between above the first gas supply unit and above the second gas supply unit can be restricted to some extent. A rod-like member, a grid-like member produced by combining a plurality of rods, or the like may be used.

The filtration device can exhibit the effect described above as long as the bubble-rising prevention zone can be formed by the generation of bubbles from the first gas supply unit. Accordingly, the top surface of the filtration tank, the top surface covering above the immersion-type filtration module, and the partition plate disposed between the bubble-rising prevention zone and the immersion-type filtration module are not essential components of the present invention. A filtration device that does not include these components is also within the intended scope of the present invention.

### INDUSTRIAL APPLICABILITY

As described above, according to the filtration device and the filtration method, the filtration cost can be reduced by improving the dissolution efficiency of oxygen in a filtration tank. Accordingly, the filtration device and the filtration method can be suitably used in an activated sludge treatment of sewage water or the like.

1. A filtration device comprising a filtration tank that stores a liquid to be treated, the liquid containing a microorganism; an immersion-type filtration module that is disposed in the filtration tank and that includes a plurality of separation membranes; and a first gas supply unit that generates bubbles for cleaning the separation membranes from below the immersion-type filtration module,
wherein the filtration device further includes a second gas supply unit that is arranged in a lower portion of the filtration tank so as to be spaced apart from the first gas supply unit and that generates bubbles for supplying oxygen, and
a bubble-rising prevention zone is formed above the second gas supply unit by the generation of the bubbles from the first gas supply unit.

2. The filtration device according to claim 1, wherein a downflow of the liquid to be treated is present in the bubble-rising prevention zone.

3. The filtration device according to claim 1, wherein a turbulence flow of the liquid to be treated is present in the bubble-rising prevention zone.

4. The filtration device according to claim 1, wherein the filtration tank has a top surface that covers at least a part of the immersion-type filtration module in top view.

5. The filtration device according to claim 1, further comprising a partition portion disposed between the bubble-rising prevention zone and the immersion-type filtration module.

6. The filtration device according to claim 1, wherein an average horizontal diameter of the bubbles generated from the first gas supply unit is larger than an average horizontal diameter of the bubbles generated from the second gas supply unit.

7. A filtration method comprising using the filtration device according to claim 1.
